(19) United States
(12) Patent Application Publication
(10) Pub. No.: US 2026/0003722 A1
(43) Pub. Date: Jan. 1, 2026

(54) COMPUTER IMPLEMENTED METHODS, SYSTEMS AND PROGRAM INSTRUCTIONS FOR DETECTING ANOMALIES IN A CORE NETWORK OF A TELECOMMUNICATIONS NETWORK

(71) Applicant: VODAFONE GROUP SERVICES LIMITED, Newbury, Berkshire (GB)

(72) Inventors: Ahmed HANY, London (GB); Yosr MOHAMED, London (GB)

(21) Appl. No.: 19/106,018

(22) PCT Filed: Aug. 15, 2023
(86) PCT No.: PCT/GB2023/052148

§ 371 Date: Feb. 24, 2025

(30) Foreign Application Priority Data
Aug. 24, 2022 (GB) 2212292.3

(51) Int. Cl. G06F 11/07

(52) U.S. Cl. CPC G06F 11/079; G06F 11/0709

(57) ABSTRACT

The computer implemented methods, systems, and program instructions detect anomalies in a core network of a telecommunications network. The method comprises: receiving data representative of streams of time series data of a plurality of Key Performance Indicators (KPIs) of the performance of nodes of the core network; comparing the received time series data for each of the KPIs to predicted time series values for each KPI generated by one or more time series analysis algorithms trained with historical data for each KPI to predict the KPI over time; determining any KPIs having deviations between the received time series data and the predicted time series data during a specific time period, wherein each deviation is an anomaly; grouping the streams of time series data for each KPI determined to be deviated to generate anomaly data; using an artificially intelligent clustering algorithm to generate a plurality of clusters, wherein each cluster comprises a subset of the KPIs determined to be deviated that have been assigned to said cluster by the artificially intelligent clustering algorithm; wherein each of the clusters is identified as having an associated root cause.

This invention relates to a computer implemented method, system and computer program instructions for detecting anomalies in a core network of a telecommunications network. In particular, the invention finds utility in relation to detecting anomalies in a core network that have propagated across several nodes in the core network, and identifying the root cause of anomalies.

### BACKGROUND

Wireless or mobile (cellular) telecommunications networks in which a mobile terminal (UE, such as a mobile handset) communicates via a radio link to a network of base stations (e.g. eNBs) or other wireless access points connected to a telecommunications network, have undergone rapid development through a number of generations. As telecommunications networks continue to evolve and more services become reliant on the performance of a telecommunications network, the reliability of the performance of telecommunications networks needs to further improve. Due to the complexity of telecommunications networks, particularly as increasingly more features and technologies are implemented through the different generations, it can become increasingly difficult to analyse the performance of the network. For example a node of the core network can be analysed using a Key Performance Indicator and collecting time series data of the KPI to determine how it varies over time. Typically a threshold alert can be implemented on the time series, which when triggered indicates that the KPI has dropped in performance. However, these threshold alerts cannot detect disturbances which do not meet the threshold but may still have an impact on the performance of the network, and it does not detect slow term degradation of the KPI, as the average value which is used for the threshold changes over time.

Furthermore it is not straightforward to determine the root cause of the threshold alert, as the root cause may originate from a separate node which caused a drop in performance that propagated around the network. Threshold alerts also do not detect deviations of KPIs on nodes which have been affected by a deviation of a KPI on another node, but were not affected enough to trigger a threshold alert. However these deviations below threshold alert levels still affect the performance of the core network, and therefore not detecting these deviations makes analysing the root cause of anomalies in the core network and improving performance of the core network more difficult.

### BRIEF SUMMARY OF THE DISCLOSURE

In devising the present invention, it has been realised that threshold-based detections of anomalies in core networks do not detect disturbances on nodes in the core network which affect the performance of the core network. Additionally, threshold-based alerts do not enable a rigorous analysis of the root cause of an anomalous event in the core network and the nodes affected in the event, making it harder to improve network performance to avoid future anomalous events.

Thus disclosed herein are computer implemented methods, systems and computer program instructions for detecting anomalies in a core network of a telecommunications network. As will be described below, the present invention determines deviations of Key Performance Indicators (KPIs) of nodes in the core network and clusters them, with each cluster having an associated root cause. This enables a detailed analysis of the root cause of anomalous events in the core network, as all of the affected nodes are associated with the cluster, despite the fact that some or many of the deviations of the KPIs would not have triggered a threshold-based alert. This therefore improves the detection and analysis of anomalous events in a core network that affect the core network's performance.

Thus, viewed from one aspect, the present invention provides a computer implemented method of detecting anomalies in a core network of a telecommunications network, comprising: receiving data representative of streams of time series data of a plurality of Key Performance Indicators (KPIs) of the performance of nodes of the core network; comparing the received time series data for each of the KPIs to predicted time series values for each KPI generated by one or more time series analysis algorithms trained with historical data for each KPI to predict the KPI over time; determining any KPIs having deviations between the received time series data and the predicted time series data during a specific time period, wherein each deviation is an anomaly; grouping the streams of time series data for each KPI determined to be deviated to generate anomaly data; using an artificially intelligent clustering algorithm to generate a plurality of clusters, wherein each cluster comprises a subset of the KPIs determined to be deviated that have been assigned to said cluster by the artificially intelligent clustering algorithm; wherein each of the clusters is identified as an event with an associated root cause.

In accordance with the present invention, anomalous events and the nodes affected are identified in the clusters provided by the clustering algorithm, leading to better detection and analysis of anomalous events which would not be possible using threshold-based alerts, which would not detect small deviations on nodes. By having a time series analysis algorithm and clustering algorithm used in combination, this enables a detailed and accurate detection and analysis of the anomalous events and root causes to be carried out, as the time series analysis algorithm is not able to distinguish between a deviation of a KPI associated with deviations on other KPIs that are part of the same event and random deviations or deviations of KPIs which are due to separate events and are not linked to each other. The present invention can detect and analyse anomalous events (clusters) which are occurring concurrently, at least in part.

In embodiments, the nodes comprise different types of nodes, the node types comprising any one or more of: SGSN, MME, GGSN, HGW, DPI, GRX Firewall, Gi Firewall. In this way, the present invention can be used for multiple different telecommunications networks and generations of networks, for example 2G, 3G, 4G, 5G and subsequent generations.

In embodiments, each node type comprises a subset of KPIs.

In embodiments, the clustering algorithm uses Dynamic Time Warping to generate the plurality of clusters. In this way, the clustering algorithm can take into account the phase shifts of time series data from different KPIs, where the phase shifts can be due to the anomaly propagating around the nodes of the core network.

In embodiments, the method additionally comprises determining the root cause of each cluster using one or more data sources.

In embodiments, the one or more data sources comprise: a planned activity schedule for the nodes; alarms data, wherein the alarms data comprises information on alarms raised on the nodes.

In embodiments, grouping the streams of time series data for each KPI determined to be deviated into anomaly data comprises using a Resiliency Matrix, wherein the Resiliency Matrix is a matrix that defines how the different node types are logically connected inside the Core Network. In this way, the present invention can enable detection and analysis of root causes of anomalies in different parts of the core network.

In embodiments, each cluster is labelled using the alarms data and/or the planned activity schedule.

In embodiments, the root cause associated with at least one of the clusters comprises a planned activity of a certain node associated with said cluster.

In embodiments, the root cause associated with at least one of the clusters comprises that if there were no planned activities on the nodes associated with the said cluster, a node associated with the said cluster having an alarm raised first chronologically within the time frame associated with the said cluster compared to the other nodes associated with the said cluster is determined to be the root cause.

In embodiments, the root cause associated with at least one of the clusters comprises that if both there was a planned activity of a certain node associated with said cluster and a node associated with said cluster has an alarm raised first chronologically within the time frame associated with said cluster compared to the other nodes associated with said cluster, determining that the planned activity and the alarm are the root cause.

In embodiments, the method comprises assigning each deviation of a KPI a severity, wherein the severity can be high, medium or low. In embodiments, the method comprises assigning each deviation of a KPI to a type, wherein the type can be: single point, pattern of the day, short-term, long-term and a level shift. In this way, the present invention can enable characterisation of the deviations in greater detail. Threshold based alerts may not detect level shifts due to the moving average value of the threshold, which is avoided with the present invention which can detect level shifts.

In embodiments, the one or more time series analysis algorithm comprises one or more of: Auto Regressive Integrated Moving Average (ARIMA) and Facebook prophet.

Viewed from another aspect, the present invention provides a system comprising: one or more processors; memory; the memory comprising instructions which, when executed by one or more of the processors, cause the processor(s) to: receive data representative of streams of time series data of a plurality of Key Performance Indicators (KPIs) of the performance of nodes of the core network; compare the received time series data for each of the KPIs to predicted time series values for each KPI generated by one or more time series analysis algorithms trained with historical data for each KPI to predict the KPI over time; determine any KPIs having deviations between the received time series data and the predicted time series data during a specific time period, wherein each deviation is an anomaly; group the time series data for each KPI determined to be deviated to generate anomaly data; use an artificially intelligent clustering algorithm to generate a plurality of clusters, wherein each cluster comprises a subset of the KPIs determined to be deviated that have been assigned to said cluster by the artificially intelligent clustering algorithm; wherein each of the clusters is identified as an event with an associated root cause.

In embodiments, the nodes comprise different types of nodes, the node types comprising any one or more of: SGSN, MME, GGSN, HGW, DPI, GRX Firewall, Gi Firewall.

In embodiments, the instructions, when executed by the one or more processors, additionally cause the processor(s) to: determine the root cause of each cluster using one or more data sources.

In embodiments, the one or more data sources comprise: a planned activity schedule for the nodes; alarms data, wherein the alarms data comprises information on alarms raised on the nodes.

In embodiments, grouping the streams of time series data for each KPI determined to be deviated into anomaly data comprises using a Resiliency Matrix, wherein the Resiliency Matrix is a matrix that defines how the different node types are logically connected inside the Core Network.

In embodiments, the root cause associated with at least one of the clusters comprises a planned activity of a certain node associated with said cluster.

In embodiments, the root cause associated with at least one of the clusters comprises that if there were no planned activities on the nodes associated with said cluster, a node associated with said cluster having an alarm raised first chronologically within the time frame associated with said cluster compared to the other nodes associated with said cluster is determined to be the root cause.

In embodiments, the root cause associated with at least one of the clusters comprises that if both there was a planned activity of a certain node associated with said cluster and a node associated with said cluster has an alarm raised first chronologically within the time frame associated with said cluster compared to the other nodes associated with said cluster, determining that the planned activity and the alarm are the root cause.

In embodiments, the one or more time series analysis algorithm comprises one or more of: Auto Regressive Integrated Moving Average (ARIMA) and Facebook prophet.

Viewed from another aspect, the present invention provides computer program instructions for detecting anomalies in a core network of a telecommunications network, wherein the computer program instructions, when executed by one or more processors, cause the processor(s) to: receive data representative of streams of time series data of a plurality of Key Performance Indicators (KPIs) of the performance of nodes of the core network; compare the received time series data for each of the KPIs to predicted time series values for each KPI generated by one or more time series analysis algorithms trained with historical data for each KPI to predict the KPI over time; determine any KPIs having deviations between the received time series data and the predicted time series data during a specific time period, wherein each deviation is an anomaly; group the time series data for each KPI determined to be deviated to generate anomaly data; use an artificially intelligent clustering algorithm to generate a plurality of clusters, wherein each cluster comprises a subset of the KPIs determined to be deviated that have been assigned to said cluster by the artificially intelligent clustering algorithm; wherein each of the clusters is identified as an event with an associated root cause.

Viewed from another aspect, the present invention provides a computer implemented method of training one or more time series analysis algorithms for use in the method described in any of the paragraphs above, comprising: receiving historical data for each Key Performance Indicator (KPI) of the nodes of the core network; training the one or more time series analysis algorithms using the historical data for each KPI of the nodes of the core network to enable the predicted time series values for each KPI to be produced for comparison against the received streams of time series data for each of the KPIs.

### BRIEF DESCRIPTION OF THE DRAWINGS

Embodiments of the invention are further described hereinafter with reference to the accompanying drawings, in which:

FIG. 1 is an example schematic of a telecommunications network;

FIG. 2 illustrates an example computer implemented method according to an aspect of the present invention;

FIG. 3 shows a graph of recorded time series data of several Key Performance Indicators (KPIs) of nodes of a core network;

FIG. 4 shows a graph of recorded time series data of several KPIs of nodes of a core network;

FIG. 5 shows a graph of recorded time series data of several KPIs of nodes of a core network;

FIG. 6 shows an example system;

FIG. 7 shows an example schematic of software modules; and

FIG. 8 shows an example computer implemented method according to an aspect of the present invention.

### DETAILED DESCRIPTION

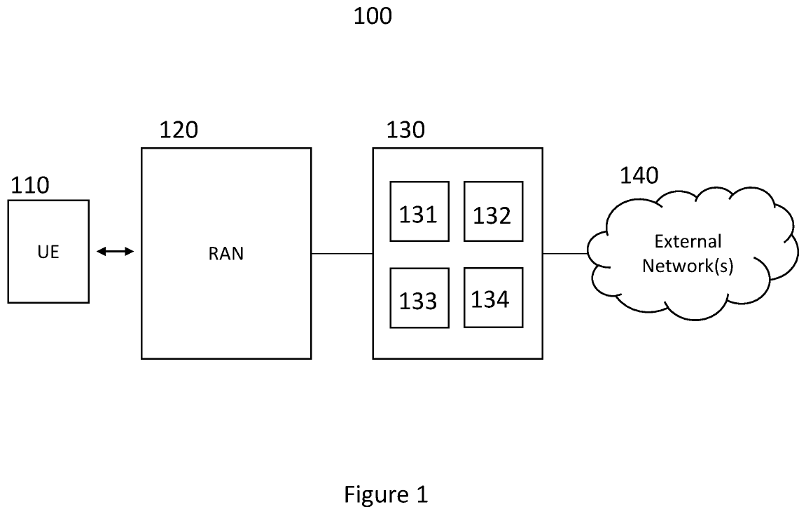

FIG. 1 illustrates an example simplified schematic of a telecommunications network 100. For example, the telecommunications network 100 can be a wireless cellular telecommunications network. The telecommunications network 100 comprises three high-level components: at least one User Equipment (UE) 110, a Radio Access Network (120) and a Core Network 130. The Core Network 130 can communicate with one or more External Networks 140 in the outside world. Depending on the generation of the telecommunications network 100, the External Networks 140 can comprise any suitable network(s), examples include the internet, Packet Data Network(s), public switched telephone network (PSTN).

The UE 110 connects to the Radio Access Network 120 (RAN), which can comprise different technologies depending on the generation of the telecommunications network 100. Typically the RAN 120 comprises base stations, antennas, base station subsystems and any other technology which connects UEs 110 to the Core Network 130. For example, in an LTE network 100, the RAN 120 is an E-UTRAN, which comprises an eNB (E-UTRAN Node B) which is responsible for handling radio communications between a UE 110 and the Core Network 130 across the air interface (the Core Network 130 being an Evolved Packet Core (EPC) in an LTE network). An eNB controls UEs 110 in one or more cell(s). LTE is a cellular system in which the eNBs provide coverage over one or more cell(s). Typically there is a plurality of eNBs within an LTE network 100.

The Core Network 130 is the infrastructure that interconnects multiple base stations and base stations subsystems together and is responsible for routing voice and data between UEs 110 and also for routing traffic to the External Networks 140. The Core Network 130 includes a lot of additional components that enable features such as roaming, handoff, etc.

The Core Network 130 comprises several node types (131, 132, 133, 134). There may be more than one of each node type in the Core Network 130, according to the number of UEs, the geographical area of the network and the volume of data to be transported across the network. Depending on their function, some of the node types connect to the RAN 120, some connect to other node types of the Core Network 130, some connect to the External Network(s) 140, and some may connect to one of more of the RAN 120, other node types of the Core Network 130 and the External Network(s) 140.

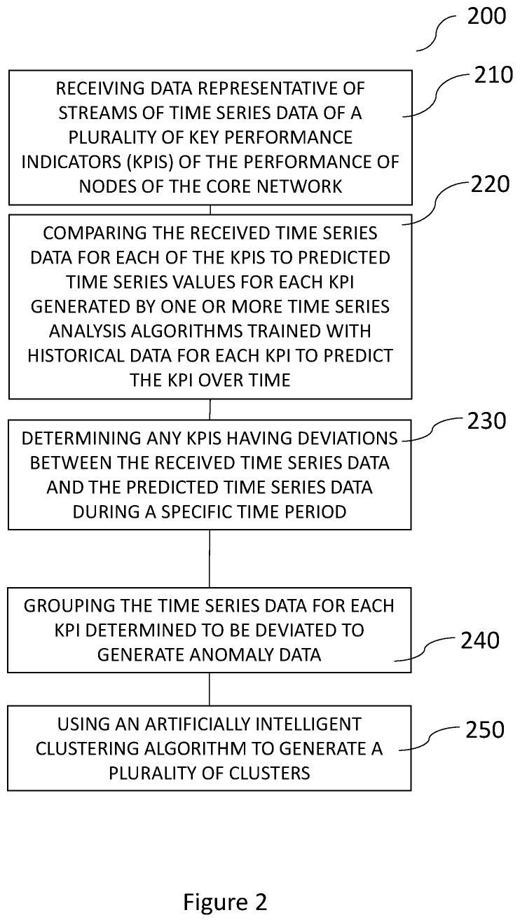

FIG. 2 illustrates an example computer implemented method 200 of detecting anomalies in a core network of a telecommunications network, such as a wireless cellular telecommunications network.

In a first step 210, the method comprises receiving data representative of streams of time series data of a plurality of Key Performance Indicators (KPIs) of the performance of nodes of the core network.

In a second step 220, the method comprises comparing the received time series data for each of the KPIs to predicted time series values for each KPI generated by one or more time series analysis algorithms trained with historical data for each KPI to predict the KPI over time.

In a third step 230, the method comprises determining any KPIs having deviations between the received time series data and the predicted time series data during a specific time period, wherein each deviation is an anomaly.

In a fourth step 240, the method comprises grouping the time series data for each KPI determined to be deviated to generate anomaly data.

In a fifth step 250, the method comprises using an artificially intelligent clustering algorithm to generate a plurality of clusters, wherein each cluster comprises a subset of the KPIs determined to be deviated that have been assigned to said cluster by the artificially intelligent algorithm. Each of the plurality of clusters is identified as an event with an associated root cause. In some examples, each cluster can be associated with multiple root causes.

The nodes can comprise different types of nodes, and can be any node of the core network 130, which are represented by nodes 131, 132, 133, 134 in FIG. 1. For example, the node types can comprise any one or more of: SGSN, MME, GGSN, HGW, DPI, GRX Firewall, Gi Firewall.

For Example, SGSN is a Serving GPRS Support Node. The function of the SGSN is to serve the UEs 110, and supports GPRS and/or UMTS. The SGSN tracks the locations of UEs 110, performs security functions and access control.

MME (Mobility Management Entity) is a node type for LTE which has a somewhat equivalent purpose as the SGSN. For example, an MME node controls the high-level operation of UEs 110 through signalling messages exchanged with the UEs 110 through the E-UTRAN. Each UE 110 is registered with a single MME. Communication between the UE 110 and the MME is across the air interface via the E-UTRAN. Signalling messages between the MME and the UE 110 comprise EPS (Evolved Packet System) Session Management (ESM) protocol messages controlling the flow of data from the UE 110 to the outside world and EPS Mobility Management (EMM) protocol messages controlling the rerouting of signalling and data flows when the UE 110 moves between eNBs within the E-UTRAN. The MME exchanges signalling traffic with a S-GW (Signalling Gateway, a component of the Core Network 130) to assist with routing data traffic. The MME also communicates with a Home Subscriber Server (HSS, another component of the Core Network 130) which stores information about user (UEs 110) registered with the network.

GGSN (Gateway GPRS Support Node) is a node type for GPRS/UTMS networks and together with the SGSN handles packet transmissions between the network and external packet switched networks, such as the Internet or an X.25 network.

HGW (Home Gateway) provides connectivity from the UE 110 to external packet data networks (PDNs) by being its point of exit and entry of traffic. This is equivalent to GGSN used in a 2G/3G network.

DPI (Deep Packet Inspection) refers to services based on inspecting the contents of packets. Usually this inspection is done for the purpose of understanding which application is creating the traffic-whether it is a VoIP packet, a P2P application, e-mail or a Web page download. Based on this identification, different actions can be taken: traffic shaping, traffic management, lawful intercept, caching and blocking.

GRX Firewall and Gi Firewall are examples of Firewalls used in mobile telecommunications networks for monitoring incoming and outgoing network traffic.

Each node type can comprise a subset of KPIs. For example, the SGSN/MME node type can comprise the following types of KPIS: SAU (Simultaneous Active Users) for 2G or 3G networks, SEAU (Simultaneously Enhanced Attached Users) for 4G networks, SAAU (Simultaneously Active Attached Users) for 4G networks, Attach Success rate (The ratio of the number of successfully performed EPS attach procedures to the number of attempted EPS attach procedures), Paging Success rate (the rate of successful page responses either as a result of first or repeated attempts to a location area), PDN success rate, CPU usage.

PDN success rate refers to the ratio of the number of successfully performed dedicated EPS bearer creation procedures by PGW (Packet Gateway) to the number of attempted dedicated EPS bearer creation procedures by PGW and is used to evaluate service availability provided by EPS and network performance. This KPI is obtained by successful dedicated EPS bearer creation procedures divided by attempted dedicated EPS bearer creation procedures.

The GGSN/HGW can comprise the following types of KPIs: Total Throughput Upload (in Gbps), Total Throughput Downlink (Gbps), Total Volume Upload (GB), Total Volume Downlink (GB), PDP Context, PDN Context.

For PDP Context, when a UE is attached to a SGSN and it is about to transfer data, it must activate a PDP (Packet Data Protocol) address. Activating a PDP address establishes an association between the current SGSN of the UE and the GGSN that anchors the PDP address. The record kept by the SGSN and the GGSN regarding this association is called the PDP context.

For PDN Context this is similar to PDP Context. Both describe the number of Sessions. PDP context is for 2G/3G networks while PDN Context is for 4G networks.

The DPI node type can comprise a Throughput KPI type. The GRX Firewall can comprise a Throughput KPI type and the Gi Firewall can comprise a Sessions KPI type. The Sessions KPI relates to the data session created by the user and navigates through the network components.

Each subset of KPIs for different node types can comprise different categories of KPIs. For example, in the subset of KPIs of the SGSN/MME, the subset can comprise the following categories: Users, Performance, Capacity. The Users category can comprise SAU, SEAU, SAAU. The Performance category can comprise Attach Success rate, Paging Success rate, PDN success rate. The Capacity category can comprise the CPU usage KPI.

For example, in the subset of KPIs of the GGSN/HGW, the subset can comprise Capacity and Sessions categories. Capacity is related to traffic (volume/throughput) while Sessions is related to count of packets (also called sessions). The Capacity category can comprise the following KPIs: Total Throughput Upload (in Gbps), Total Throughput Downlink (Gbps), Total Volume Upload (GB), Total Volume Downlink (GB). The Sessions category can comprise the KPIs: PDP Context, PDN context.

For the subset of KPIs for the DPI node, the subset can comprise a Capacity category, which comprises the Throughput KPI.

For the subset of KPIs for the GRX Firewall node, the subset can comprise a Capacity category, which comprises the Throughput KPI.

For the subset of KPIs for the Gi Firewall node, the subset can comprise a Sessions category, which comprises the Sessions KPI.

The examples of KPIs provided above are just a sample of the KPIs which can be analysed in a Core Network. The actual number of KPIs used can be, for example, 350 KPIs. Other numbers of KPIs can be used in other examples.

The streams of time series data can cover a time period which is longer than the specific time period that is used in third step 230 when determining the KPIs having deviations. For example, a user may to choose to obtain clusters for a specific time period which is shorter than the length of the streams received in first step 210. Alternatively the steams of time series data received in first step 210 can cover the specific time period. The specific time period can be, for example, two days, or another period of time.

The one or more time series analysis algorithms used in second step 220 to compare the received time series data to the time series data generated can be any suitable algorithm including Facebook Prophet, or an Autoregressive Integrated Moving Average (ARIMA) model. The one or more time series analysis algorithm(s) creates forecasted data for the KPIs by using historical data for each KPI to predict data for each KPI over time. The historical data needs to cover a time period which precedes the specific time period used to determine the KPI deviations, but does not need to be contiguous with the specific time period.

Deviations of the received time series data for the KPIs compared to the predicted time series values for each KPI can be called anomalies. The one or more time series analysis algorithms can have a confidence interval for the predicted time series values, and any values outside of that confidence interval are determined to be deviations. In some examples the confidence interval can be set by a user of the one or more time series analysis algorithm(s). In other examples the time series analysis algorithm is responsible for determining the confidence interval. For example, the confidence interval is calculated based on the mean and standard deviation of a two week interval before the day of the anomalies which are being analysed. An error is calculated between the received time series data and the predicted one. Based on how much standard deviations are in the error, this can be used to classify whether the day is an anomaly or not and if it's an anomaly, the severity type of the anomaly or anomalies can be set (low, mid or high).

KPIs that are determined to have deviations during the specific time period are grouped together to generate anomaly data. In some examples, as an additional step of grouping the KPIs with deviations into anomaly data, the KPIs with deviations are grouped together using a Resiliency Matrix. The Resiliency Matrix is a matrix that defines how the different node types (131, 132, 133, 134) are logically connected inside the core network (130). The Resiliency Matrix can comprise resiliency regions which define groups of node types which are affected by each other's performance. Therefore grouping the KPIs with deviations into anomaly data can comprise grouping the KPIs with deviations into different anomaly datasets, where each anomaly dataset is associated with a different resiliency region of the resiliency matrix.

Following the grouping of the time series data for each KPI determined to be deviated to generate anomaly data, the method proceeds to the fifth step 250 of the method which comprises using an artificially intelligent clustering algorithm to generate a plurality of clusters, where each cluster comprises a subset of the KPIs determined to be deviated that have been assigned to said cluster by the clustering algorithm. The artificially intelligent clustering algorithm can be a K-Means clustering technique, which uses Dynamic Time Warping (DTW) as the distance metric. DTW is advantageous for clustering time series together because it takes phase shifts into consideration when comparing time series. It therefore improves clustering of time series which have a similar pattern, and therefore highly correlated, but are slightly shifted in time, compared to using Euclidian distance as the distance metric which does not take into account the phase shifts. DTW therefore better correlates anomalies/deviations that initially started on one node and propagated around the Core Network 130 causing phase shifts between the time series of different nodes.

In an example, the input to the clustering is the last 2 days of the time series of deviating KPIs aggregated to daily level. The time series of the KPIs may initially be in hourly resolution. These can be aggregated each day by calculating the 70^{th} percentile (to go from the hourly to the daily level) before the clustering step. In other examples, the time series of deviating KPIs are kept at hourly resolution, with no daily aggregation, based on whether the clustering algorithm is performing effectively.

In some examples, it can be determined that some nodes are deviating due to compensating each other (i.e., in the core network 130 if a particular node has degradation, other nodes compensate the loss by having an increase in some of the KPIs). In some examples to better correlate the KPIs, the nodes that compensate the loss by increasing their KPIs can be reciprocated in order to successfully cluster them together.

In examples where a Resiliency Matrix is used to group the KPIs with deviations into different anomaly datasets associated with different resiliency regions, the clustering algorithm may run separate parallel clustering for different resiliency regions.

Following the clustering, several clusters are formed which each have an associated root cause.

Each cluster may be identified as an event which occurred in the core network 130, with an associated root cause. The labelling of each cluster to its root cause can be determined using one or more data sources. The one or more data sources can comprise a planned activity schedule for the nodes, and alarms data. The alarms data comprises information on alarms that were raised on the nodes. Specifically, the planned activity schedule and alarms data used to determine the root causes is associated with the specific time period in which the KPIs were determined to be deviated. It is to be envisaged that in rare situations the root cause associated a cluster may be not be found and so may not labelled, or may be labelled as an unknown root cause. This may occur, for example, if data from one or more data sources is missing or incomplete. In some very rare circumstances the root cause may not be found even if the data from the one or more data sources is complete. In such rare circumstances, the cluster can be labelled as a unknown root cause. The methods 200, system 600 and computer program instructions 630 disclosed herein at least provide clusters which are identified as having an associated root cause which provides better detection and analysis of anomalous events. Regardless of subsequent analysis to determine what the associated root causes are for each cluster, the grouping of KPIs into clusters which are each identified as having a root cause can beneficially identify KPIs, and thus nodes, involved in an anomalous event which previously wouldn't have been associated with the anomalous event using threshold based alerts on nodes, and thus improves detection of anomalous events.

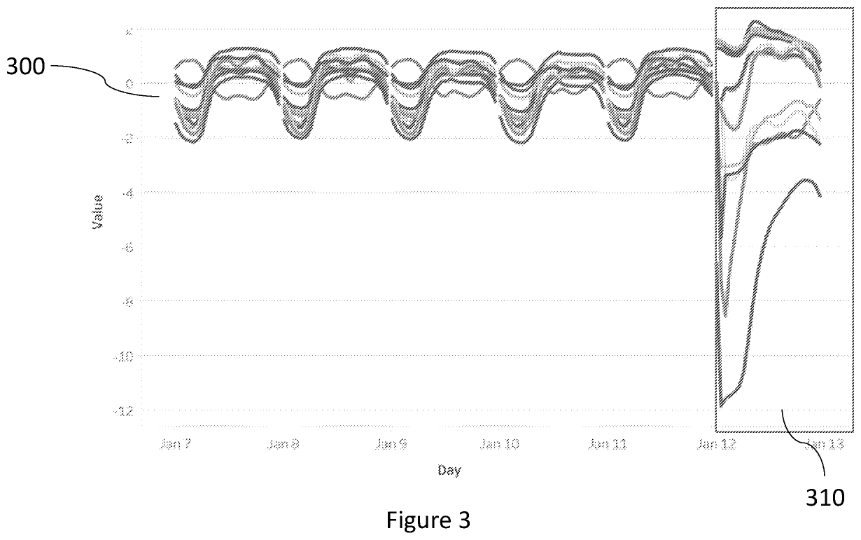

FIGS. 3, 4, 5 illustrate example time series data streams 300, 400, 500 of multiple nodes occurring at different times, where an event (cluster) was identified using method 200 in each case and is visualized as occurring in boxes 310, 410, 510. The associated root cause of each cluster was identified using the alarms data and planned activities schedule.

In FIG. 3, an anomaly was detected on a first example node which propagated onto other nodes. All of the affected KPIs were detected as anomalies (deviations) and grouped into one event using the clustering algorithm. The root cause was extracted from an alarm raised on the first example node. The alarm raised indicated that a transceiver component of the first example node had failed. In this example this was the only alarm that was raised, however in other examples the anomaly caused by one node and the resulting alarm may cause other alarms to occur in other nodes. Therefore in some examples, where there were no planned activities on the nodes associated with the cluster, a node associated with the cluster having an alarm raised first chronologically within the time frame associated with the cluster compared to the other nodes associated with the cluster is determined to be the root cause.

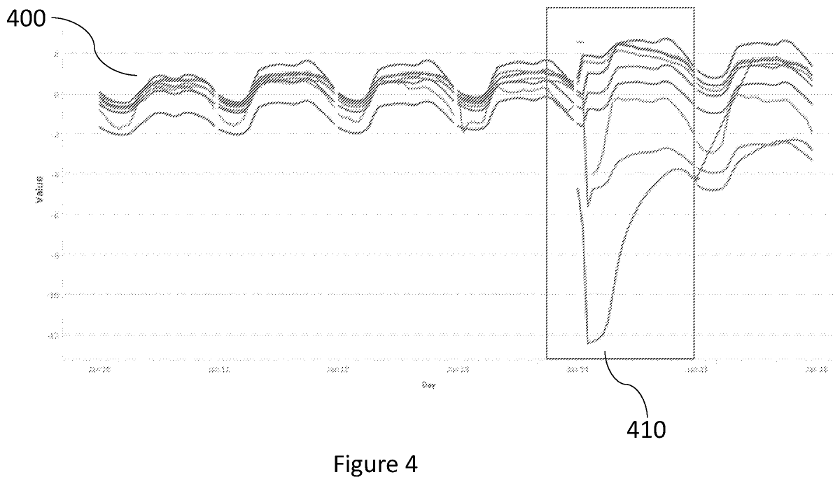

In FIG. 4, an anomaly was detected on a second example node which propagated to other nodes. All of the affected KPIs were detected as anomalies (deviations) and grouped into one event using the clustering algorithm. The root cause was extracted from the planned activities schedule where an activity was planned on the second example node.

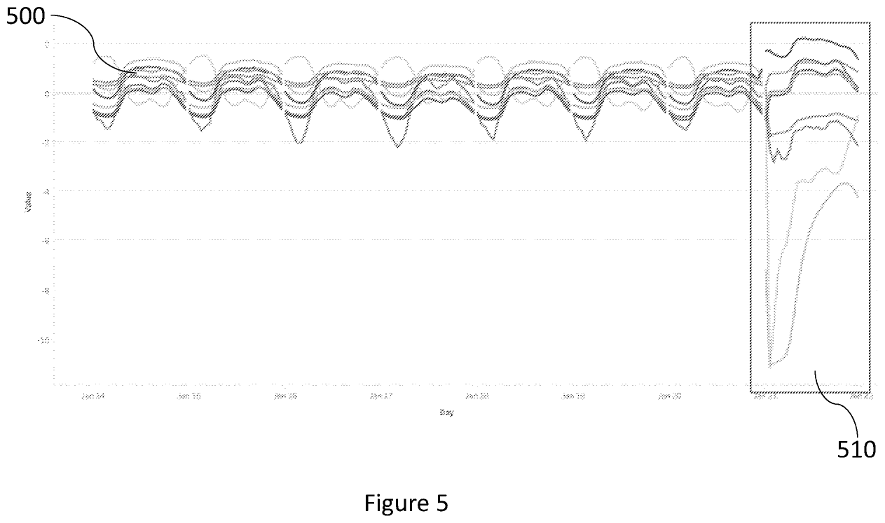

In FIG. 5, an anomaly was detected on a third example node which propagated to other nodes. All of the affected KPIs were detected as anomalies (deviations) and grouped into one event using the clustering algorithm. The root cause was extracted from both the planned activities and alarms data where an activity was planned on the third example node and an alarm was raised on the third example node, where the CPU of the third node went over a Max threshold and the Attached Subs 2G-Gb was under a threshold. This means the number of attached subscribers went below the specified threshold (in the alarming system) to raise an alarm. Therefore in some examples, the root cause associated with the anomaly data of at least one of the clusters comprises that if both there was a planned activity of a certain node associated with said cluster and a node associated with said cluster has an alarm raised first chronologically within the time frame associated with said cluster compared to the other nodes associated with said cluster, determining that the planned activity and the alarm are the root cause.

The method 200 therefore provides clusters which identify anomalous events and the nodes affected, leading to better detection and analysis of anomalous events which would not be possible using threshold-based alerts, which would not detect small deviations on nodes. By having a time series analysis algorithm and clustering algorithm used in combination, this enables a detailed and accurate detection and analysis of the anomalous events and root causes to be carried out, as the time series analysis algorithm is not able to distinguish between a deviation of a KPI associated with deviations on other KPIs that are part of the same event and random deviations or deviations of KPIs which are due to separate events and are not linked to each other. The present invention can detect and analyse anomalous events (clusters) which are occurring concurrently, at least in part.

The method 200 can comprise assigning each deviation of a KPI a severity. The severity can be high, medium or low. The thresholds for determining which severity the deviation is classified as can be determined using statistics of historic deviations and a rules-based algorithm.

The method 200 can comprise assigning each deviation of a KPI to a type. The type can be: single point, pattern of the day, short-term, long-term, and detecting a level shift.

A single point anomaly can be defined as the deviation lasted for an hour or less.

A pattern of the day deviation can be defined as lasting longer than an hour but shorter than 24 hours.

A short term deviation can be defined as a deviation which is longer that one consecutive day but no more than 3 consecutive days.

A long term deviation can be defined as a deviation which is present for more than 3 consecutive days.

A level shift deviation could be a short-term level shift, a long-term level shift or a long-term anomalies level shift.

A short-term level shift can be defined as a short term deviation with a level shift. The level returns to normal after these 3 days.

The long-term level shift can be defined as deviations present for more than 3 consecutive days and a significant change in level is detected before and after the day of the shift.

The long-term anomalies level shift can be defined as a long-term level shift with a change in the normal daily seasonal pattern.

Following the clustering and root cause analysis, the method may comprise creating a visualization report for a user, which may present the clusters with associated root causes, and a breakdown of the severity and types of deviations associated with clusters. The report may be presented in a program such as Tableau or Microsoft Power BI, or another data visualization software, for example.

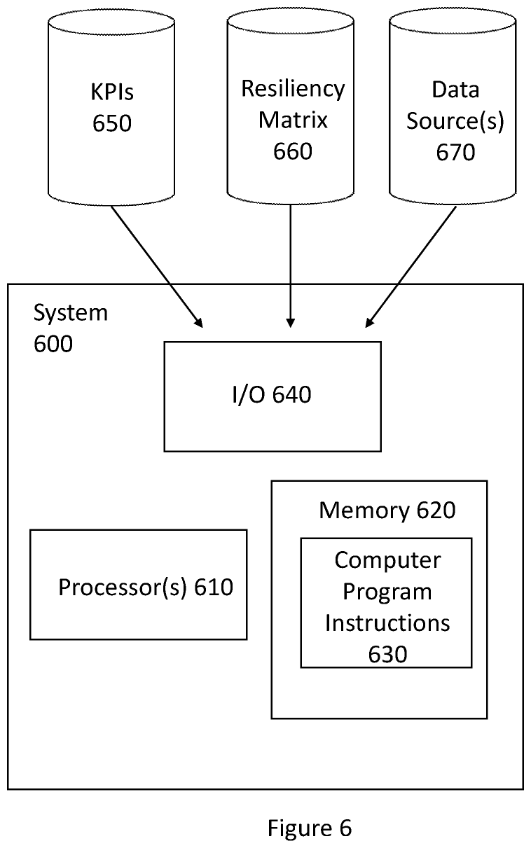

FIG. 6 shows an example system 600 in accordance with an aspect of the invention. The system 600 comprises one or more processors 610, memory 620, the memory comprising instructions 630. The system 600 may be an instance of a virtual machine spun up in a cloud computing server, or a dedicated server connected to the Internet. The components of the system 600 may be in a distributed computing environment.

The instructions 630 are computer program instructions in 630 in the form of software which, when executed by one or more of the processors, cause the processor(s) to: receive data representative of streams of time series data of plurality of Key Performance Indicators (KPIs) of the performance of nodes of a core network; compare the received time series data for each of the KPIs to predicted time series values for each KPI generated by one or more time series analysis algorithms trained with historical data for each KPI to predict the KPI over time; determine any KPIs having deviations between the received time series data and the predicted time series data during a specific time period, wherein each deviation is an anomaly; group the time series data for each KPI determined to be deviated to generate anomaly data; use an artificially intelligent clustering algorithm to generate a plurality of clusters, wherein each cluster comprises a subset of the KPIs determined to be deviated that have been assigned to said cluster by the artificially intelligent clustering algorithm; wherein each of the clusters is identified as an event with an associated root cause. There may be one or more associated root causes for each event.

The one or more time series algorithms and the clustering algorithm may be stored on the memory 620 or may be stored and run elsewhere and accessed by the system via an Input/Output interface 640 of the system 600.

The nodes can comprise different types of nodes. The node types comprising any one or more of: SGSN/MME, GGSN/HGW, DPI, GRX Firewall, Gi Firewall. In some examples, there are other node types.

Each node type can comprise a subset of KPIs. There can be a large number of KPIs which the system receives the streams of time series data for. For example there can be 350 KPIs.

The clustering algorithm used by the system 600 can use Dynamic Time Warping (DTW) to generate the plurality of clusters from different KPIs.

As illustrated in the example of FIG. 6, the system can comprise an Input/Output interface 640, which can be arranged to receive data from external data stores. For example, the system 600 can be arranged to receive one or more of: the streams of time series data 650 of the KPIs, a resiliency matrix 660, data source(s) 670. The data source(s) 670 can comprise a planned activity schedule for the nodes and alarms data. The alarms data comprises information on alarms raised on the nodes. The Resiliency Matrix defines how the nodes are logically connected in the core network.

The system can be arranged to determine the root cause of each cluster using the one or more data sources 670.

The root cause associated with at least one of the clusters can comprise a planned activity of a certain node. For example, see FIG. 4.

The root cause associated with at least one of the clusters comprises that if there were no planned activities on the nodes associated with said cluster, a node associated with the cluster having an alarm raised first chronologically within the time frame associated with said cluster compared to the other nodes associated with said cluster is determined to be the root cause. For example, see FIG. 3.

The root cause associated with at least one of the clusters comprises that if both there was a planned activity of a certain node associated with said cluster and a node associated with said cluster has an alarm raised first chronologically within the time frame associated with said cluster compared to the other nodes associated with said cluster, determining that the planned activity and the alarm are the root cause. For example, see FIG. 5.

The system can be arranged so that each deviation of a KPI is assigned a severity, wherein the severity can be high, medium or low. The system can be arranged so that each deviation of a KPI is assigned to a type, wherein the type can be: single point, pattern of the day, short-term, long-term and detecting a level shift. The definitions of these are provided above.

The one or more time series analysis algorithm that the system uses can comprise one or more of: Auto Regressive Integrated Moving Average (ARIMA) and Facebook prophet.

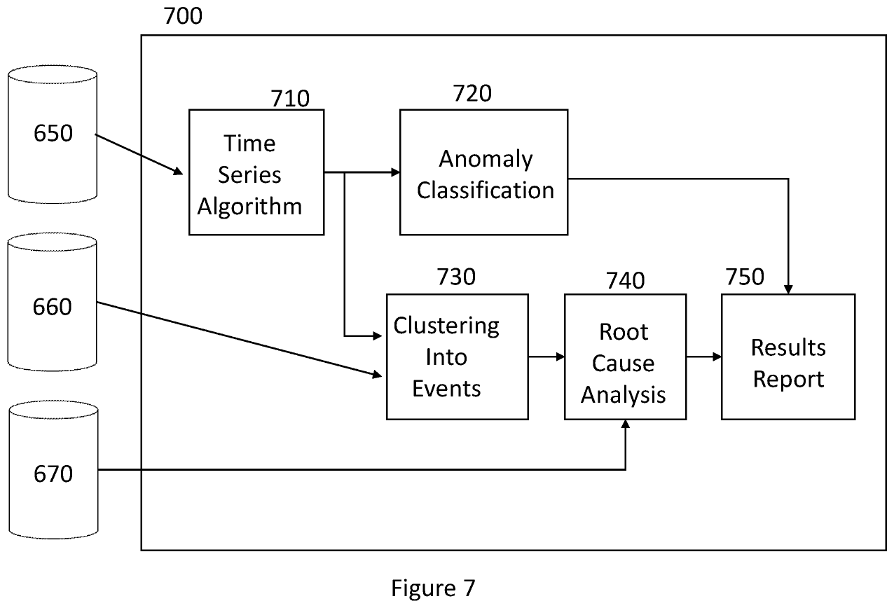

FIG. 7 illustrates an example visualization of a control flow of software modules 700 in accordance with an example system 600, for performing the instructions stored on the memory. The software modules may be stored in the same memory or are stored in different memories in a distributed computing environment.

For example the Time Series Algorithm software module 710 receives the streams of time series data 650 of the KPIs, which then compares the received time series data for each of the KPIs to predicted time series values for each KPI generated by the one or more time series analysis algorithms trained with the historical data for each KPI to predict the KPI over time. The deviated KPIs are provided to the Clustering Into Events module 730 and the Anomaly Classification Software module 720. The Clustering software module 730 in this example receives data from the Resiliency Matrix which is used in the grouping of the KPIs as described above. The Clustering software module 730 provides the clusters to the Root Cause Analysis software module 740. The Root Cause Analysis software module 740 receives data from the data source(s) 670 (for example alarms data and/or planned activities schedule). The results of the Root cause Analysis is provided to the Results Report software module 750 along with the anomaly classifications of the deviations from the Anomaly Classification software module 720.

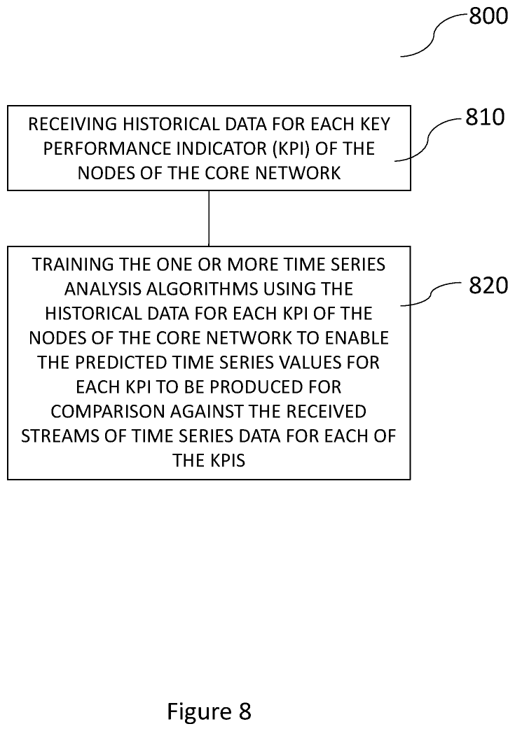

FIG. 8 illustrates an example method 800 of training one or more time series analysis algorithms for use in the method 200. The method 800 comprises: in a first step 810, receiving the historical data for each Key Performance Indicator (KPI) of the nodes of the core network; in a second step 820, training the time series analysis algorithms using the historical data for each KPI of the nodes of the core network to enable the predicted time series values for each KPI be produced for comparison against received time series data for each of the KPIs to determine any KPIs having deviations. For example, the one or more time series analysis algorithms may use a supervised learning (Machine Learning) approach, using a regression model.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A computer implemented method of detecting anomalies in a core network of a telecommunications network, comprising:
receiving data representative of streams of time series data of a plurality of Key Performance Indicators (KPIs) of the performance of nodes of the core network;
comparing the received time series data for each of the KPIs to predicted time series values for each KPI generated by one or more time series analysis algorithms trained with historical data for each KPI to predict the KPI over time;
determining any KPIs having deviations between the received time series data and the predicted time series data during a specific time period, wherein each deviation is an anomaly;
grouping the streams of time series data for each KPI determined to be deviated to generate anomaly data; and
using an artificially intelligent clustering algorithm to generate a plurality of clusters, wherein each cluster comprises a subset of the KPIs determined to be deviated that have been assigned to said cluster by the artificially intelligent clustering algorithm;
wherein each of the clusters is identified as an event with an associated root cause.

2. The method as claimed in claim 1, wherein the nodes comprise different types of nodes, the node types comprising any one or more of SGSN, MME, GGSN, HGW, DPI, GRX Firewall, Gi Firewall.

3. The method as claimed in claim 2, wherein each node type comprises a subset of KPIs.

4. The method as claimed in claim 1, wherein the clustering algorithm uses Dynamic Time Warping to generate the plurality of clusters.

5. The method as claimed in claim 1, wherein the method additionally comprises determining the root cause of each cluster using one or more data sources.

6. The method as claimed in claim 1, wherein the one or more data sources comprise:
a planned activity schedule for the nodes; and
alarms data, wherein the alarms data comprises information on alarms raised on the nodes.

7. The method as claimed in claim 1, wherein grouping the streams of time series data for each KPI determined to be deviated into anomaly data comprises using a Resiliency Matrix, wherein the Resiliency Matrix is a matrix that defines how the different node types are logically connected inside the Core Network.

8. The method as claimed in claim 6, wherein each cluster is labelled using the alarms data and/or the planned activity schedule.

9. The method as claimed in claim 6, wherein the root cause associated with at least one of the clusters comprises a planned activity of a certain node associated with said cluster.

10. The method as claimed in claim 6, wherein the root cause associated with at least one of the clusters comprises that if there were no planned activities on the nodes associated with the said cluster, a node associated with the said cluster having an alarm raised first chronologically within the time frame associated with the said cluster compared to the other nodes associated with the said cluster is determined to be the root cause.

11. The method as claimed in claim 6, wherein the root cause associated with at least one of the clusters comprises that if both there was a planned activity of a certain node associated with said cluster and a node associated with said cluster has an alarm raised first chronologically within the time frame associated with said cluster compared to the other nodes associated with said cluster, determining that the planned activity and the alarm are the root cause.

12. The method as claimed in claim 1, wherein the method comprises assigning each deviation of a KPI a severity, wherein the severity can be high, medium or low.

13. The method as claimed in claim 1, wherein the method comprises assigning each deviation of a KPI to a type, wherein the type can be single point, pattern of the day, short-term, long-term and a level shift.

14. The method as claimed in claim 1, wherein the one or more time series analysis algorithm comprises one or more of Auto Regressive Integrated Moving Average (ARIMA) and Facebook prophet.

15. A system comprising:
one or more processor(s); and
memory;
the memory comprising instructions which, when executed by one or more of the processors, cause the processor(s) to:
receive data representative of streams of time series data of a plurality of Key Performance Indicators (KPIs) of the performance of nodes of the core network;
compare the received time series data for each of the KPIs to predicted time series values for each KPI generated by one or more time series analysis algorithms trained with historical data for each KPI to predict the KPI over time;
determine any KPIs having deviations between the received time series data and the predicted time series data during a specific time period, wherein each deviation is an anomaly;
group the time series data for each KPI determined to be deviated to generate anomaly data; and
use an artificially intelligent clustering algorithm to generate a plurality of clusters, wherein each cluster comprises a subset of the KPIs determined to be deviated that have been assigned to said cluster by the artificially intelligent clustering algorithm;
wherein each of the clusters is identified as an event with an associated root cause.

16. The system as claimed in claim 15, wherein the nodes comprise different types of nodes, the node types comprising any one or more of SGSN, MME, GGSN, HGW, DPI, GRX Firewall, Gi Firewall.

17. The system as claimed in claim 16, wherein the instructions, when executed by the one or more processors, additionally cause the processor(s) to determine the root cause of each cluster using one or more data sources.

18. The system as claimed in claim 15, wherein the one or more data sources comprise:
a planned activity schedule for the nodes; and
alarms data, wherein the alarms data comprises information on alarms raised on the nodes.

19-23. (canceled)

24. Computer program instructions for detecting anomalies in a core network of a telecommunications network, wherein the computer program instructions, when executed by one or more processors, cause the processor(s) to:
receive data representative of streams of time series data of a plurality of Key Performance Indicators (KPIs) of the performance of nodes of the core network;
compare the received time series data for each of the KPIs to predicted time series values for each KPI generated by one or more time series analysis algorithms trained with historical data for each KPI to predict the KPI over time;
determine any KPIs having deviations between the received time series data and the predicted time series data during a specific time period, wherein each deviation is an anomaly;
group the time series data for each KPI determined to be deviated to generate anomaly data; and
use an artificially intelligent clustering algorithm to generate a plurality of clusters, wherein each cluster comprises a subset of the KPIs determined to be deviated that have been assigned to said cluster by the artificially intelligent clustering algorithm;
wherein each of the clusters is identified as an event with an associated root cause.

25. The computer implemented method of training one or more time series analysis algorithms for use in the method of claim 1, comprising:
receiving historical data for each Key Performance Indicator (KPI) of the nodes of the core network; and
training the one or more time series analysis algorithms using the historical data for each KPI of the nodes of the core network to enable the predicted time series values for each KPI to be produced for comparison against the received streams of time series data for each of the KPIs.
